(19) United States
(12) Patent Application Publication
(10) Pub. No.: US 2004/0228507 A1
(43) Pub. Date: Nov. 18, 2004

(54) Authentication system

(76) Inventor: Christopher van Es, Reading (GB)

Correspondence Address: SWIDLER BERLIN SHEREFF FRIEDMAN, LLP, 3000 K STREET, NW, BOX IP, WASHINGTON, DC, 20007, US

(21) Appl. No.: 10/673,322

(22) Filed: Sep. 30, 2003

(30) Foreign Application Priority Data
May 14, 2003 (GB) 0311097.0

(51) Int. Cl. G06K 9/00

(52) U.S. Cl. 382/124

(57) ABSTRACT

A method of authenticating the identity of a user is described. Each of a plurality of parts of the user's body are placed, in sequence, on a biometric contact sensor at a sensing position.

A data set of biometric contact characteristics for each of the plurality of body parts is obtained from the sensor.

Each data set is compared with authentic versions stored in a database and an authentication signal is issued if the data sets satisfactorily match the corresponding authentic versions.

This invention relates to authentication of a user and, in particular, to a biometric contact sensor and its method of operation for achieving this purpose.

Fingerprint sensors are well known biometric contact sensors that are used as a means for confirming the identity of an individual in order to grant access to a secure environment or for logging on to a computer system. Three types of fingerprint sensors are typically used. These are capacitive, optical and thermal sensors. A capacitive sensor comprises an array of miniature capacitors in which the surface of the skin of a fingertip placed on the sensor acts as a capacitive pole. As such the capacitance of each miniature capacitor depends on whether a ridge or furrow of the fingerprint forms the capacitive pole of that particular miniature capacitor. Optical sensors function by illuminating the fingertip and capturing an image using a CCD or CMOS camera. The third type of sensor, the thermal sensor, measures the small temperature difference between the ridges and furrows of the fingertip.

However, a problem exists regarding the security of such fingerprint sensors since, under certain circumstances, it is possible to gain access to the secure environment protected by a fingerprint sensor using the latent image of a fingerprint left on the device by the preceding user. It has been found that it is possible to use a latent image to gain access to the secure environment protected by the fingerprint sensor by carefully placing a plastic bag filled with water on to the sensor's surface or even merely by breathing on the sensor's surface.

A proposed solution is to provide a cover that slides over the sensor when it is not being used. The underside of the cover has a sponge loaded with a suitable solvent to remove the latent image. However, this increases the complexity of the sensor, requires maintenance and is straightforward to defeat. Clearly, there exists a need for a fingerprint sensor that combines the ease of use of a conventional sensor whilst offering higher security.

In accordance with one aspect of the present invention, there is provided a method of authenticating the identity of a user, the method comprising:

a. placing, in sequence, each of a plurality of parts of the user's body on a biometric contact sensor at a sensing position;

b. obtaining from the sensor a data set of biometric contact characteristics for each of the plurality of body parts;

c. comparing each data set with authentic versions stored in a database; and,

d. issuing an authentication signal if the data sets satisfactorily match the corresponding authentic versions.

Hence, the invention utilises the fact that the latent image of a body part can be obscured by placing another body part on top of it. The invention thus prevents the use of a latent image left upon the biometric contact sensor by the preceding user in order to gain access to the secure environment that it protects.

In a preferred embodiment, the body parts are the user's fingertips and the biometric contact sensor is a fingerprint sensor.

Typically, each part of the user's body must be placed on the biometric contact sensor within a predetermined time period before the authentication signal will be issued.

In a preferred embodiment, before issuing the authentication signal, it is confirmed that the sequence of data sets was obtained in a predetermined order.

Any suitable algorithm may be used to compare the data sets with the authentic versions. However, either a minutiae based algorithm or a correlation based algorithm will typically be used.

In accordance with a second aspect of the present invention, there is provided apparatus for authenticating a user, the apparatus comprising a fingerprint sensor capable of sensing only one fingerprint at a time, and a processor and a database adapted to perform a method according to the first aspect of the present invention.

Any fingerprint sensor may be used with the apparatus but typically, the fingerprint sensor will be a capacitive sensor, an optical sensor or a thermal sensor.

The apparatus may further comprise a data input device, for example, to enter a user name or number. The data input device may be any suitable data input device but typically, it will be a keypad or smart card reader.

In accordance with a third aspect of the present invention, there is provided a method of authenticating the identity of a user, the method comprising:

a. obtaining a sequence of data sets of biometric characteristics of the user, each data set relating to one of a plurality of parts of the user's body;

b. comparing each data set with authentic versions stored in a database;

c. monitoring the order in which the sequence of data sets was obtained; and,

d. issuing an authentication signal if the data sets satisfactorily match the corresponding authentic versions and the sequence of data sets was obtained in a predetermined order.

Biometric characteristics may be obtained for any part of the user's body. However, typically, the plurality of parts of the user's body will include the user's fingertips, retinas or face or a combination of any of these.

Various types of sensors may be used to perform this aspect of the invention. For example, a retina scanner may be used to obtain biometric characteristics of a user's retina and a fingerprint sensor may be used to obtain biometric characteristics of a user's fingertips.

Such sensors may be capable of obtaining more than one data set of biometric characteristics at a time. For example, the biometric characteristics of both retinas or of several fingertips may be obtained simultaneously.

An embodiment of the invention will now be described with reference to the accompanying drawings, in which:

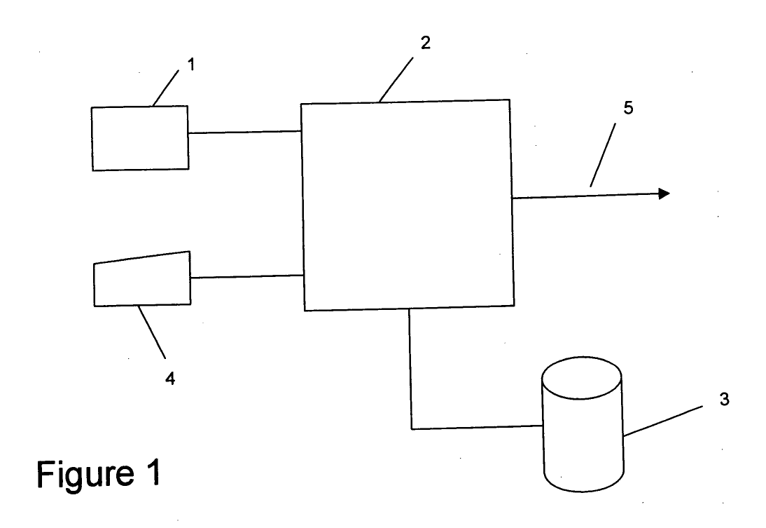

FIG. 1 shows a schematic of apparatus according to the invention; and,

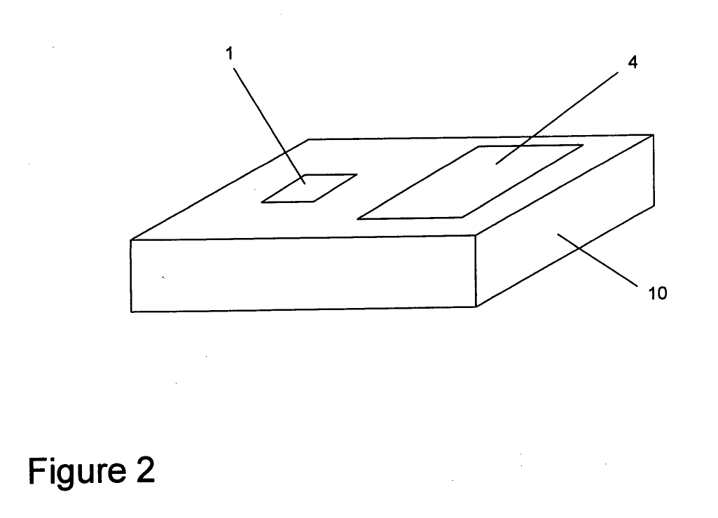

FIG. 2 shows a device incorporating the apparatus of FIG. 1.

FIG. 1 shows a fingerprint sensor 1 attached to a processor 2 to which is also connected a database 3 and a data input device 4. The fingerprint sensor 1 has a sensor array (not shown) that is sized such that it can only sense one fingerprint at a time. A device 10 incorporating the fingerprint sensor 1 and data input device 4, in the form of a keypad, is shown in FIG. 2.

The database 3 stores authentic versions of the fingerprint data sets of users authorised to access the system protected by the fingerprint sensor 1. The fingerprint sensor 1 may be of any known type including capacitive, optical and thermal variants. It may be used, for example, to control access to a computer system or to unlock the door to a secure room.

The data input device 4 may be any of a variety of such devices, for example, a keypad or touchscreen. In this example, the data input device 4 is a keypad. A user wishing to access the secure environment must firstly enter a user name or number into the data input device 4. This identifies to the processor 2 who the user claims to be. In order to authenticate his identity, the user must then place each of his required fingertips on the fingerprint sensor 1 in sequence and in the correct order. For example, the system may be configured such that in order for a particular user to gain access, that user must place the index, ring and middle fingers of his right hand followed by the thumb of his left hand on the fingerprint sensor 1 in that order.

The fingerprint sensor 1 obtains a fingerprint data set for each fingertip placed upon it. This fingerprint data set is passed to the processor 2 which compares it with the authentic versions of the fingerprint data sets of authorised users already recorded that are stored in database 3. The processor 2 performs this comparison using any one of many suitable algorithms to confirm that a satisfactory match exists between the fingerprint data set obtained by the fingerprint sensor 1 and the corresponding authentic version stored in data base 3, that is to say that there is a sufficient correlation between the two data sets that the identity of the user can be assumed to be authentic.

Typically, either a minutiae-based algorithm or a correlation-based algorithm will be used. The minutiae-based algorithms isolate the minutiae points of a fingerprint (interruptions to the lines upon the fingertips) and determine their relative placement on the finger whilst the correlation-based algorithm directly compares the two fingerprint data sets to determine whether a sufficiently high correlation exists between them.

Provided that the results of this comparison by processor 2 confirm that the fingertips placed on the fingerprint sensor do indeed belong to the user then the processor 2 proceeds to confirm that the fingertips of the user were placed on the fingerprint sensor 1 in the required order. If this criterion is met, then the processor 2 will issue an authentication signal on output indicating that the identity of the user is authentic.

In a variation of this embodiment, the apparatus can be provided with a display (not shown) and the processor 2 is adapted to cause the display to indicate which fingertip the user must place on the fingerprint sensor 1 next. This allows the required order to be changed each time the user uses the system or at other, for example, random intervals.

The output 5 may be in any one of a variety of known formats. For example, it may be a USB output for connection to a personal computer or other electronic device or alternatively, it may be a wireless medium such as a Bluetooth connection.

A further requirement that may be imposed is that each fingertip of the user must be placed on the fingerprint sensor within a predetermined time period. This will allow the processor 2 to revert to the beginning of the authentication process if a user only partially completes a previous authentication.

Aside from using second and subsequent placement of fingertips on the fingerprint sensor 1 to obscure the latent image of a first fingerprint, the invention, as described with respect to this embodiment, provides an additional advantage. That is, by having to know which fingers must be placed on the fingerprint sensor 1 and in which order, a certain level of “password” protection is also afforded by the system.

A further level of security can be provided if, instead of data input device 4 being a key pad, a smart card reader is used into which the user inserts a smart card unique to him instead of entering a user name or number.

Another possibility is to remove data input device 4 altogether and for the user merely to place the correct fingertips on the fingerprint sensor 1 in the correct order. In this instance, the processor 2 must infer the identity of the user from the fingerprint data sets stored in database 3.

We claim:

1. A method of authenticating the identity of a user, the method comprising:
a. placing, in sequence, each of a plurality of parts of the user's body on a biometric contact sensor at a sensing position;
b. obtaining from the sensor a data set of biometric contact characteristics for each of the plurality of body parts;
c. comparing each data set with authentic versions stored in a database; and,
d. issuing an authentication signal if the data sets satisfactorily match the corresponding authentic versions.

2. A method according to claim 1, wherein the body parts are the user's fingertips and the biometric contact sensor is a fingerprint sensor.

3. A method according to claim 1, wherein each part of the user's body must be placed on the biometric contact sensor within a predetermined time period before the authentication signal will be issued.

4. A method according to claim 1, further comprising the step of confirming that the sequence of data sets was obtained in a predetermined order before issuing the authentication signal.

5. A method according to claim 1, wherein the data sets are compared with the authentic versions using a minutiae based algorithm.

6. A method according to claim 1, wherein the data sets are compared with the authentic versions using a correlation based algorithm.

7. Apparatus for authenticating a user, the apparatus comprising a fingerprint sensor capable of sensing only one fingerprint at a time, and a processor and a database adapted to perform a method according to claim 1.

8. Apparatus according to claim 7, wherein the fingerprint sensor is a capacitive sensor.

9. Apparatus according to claim 7, wherein the fingerprint sensor is an optical sensor.

10. Apparatus according to claim 7, wherein the fingerprint sensor is a thermal sensor.

11. Apparatus according to any of claim 7, further comprising a data input device.

12. Apparatus according to claim 11, wherein the data input device is a keypad.

13. Apparatus according to claim 11, wherein the data input device is a smart card reader.

14. A method of authenticating the identity of a user, the method comprising:
a. obtaining a sequence of data sets of biometric characteristics of the user, each data set relating to one of a plurality of parts of the user's body;
b. comparing each data set with authentic versions stored in a database;
c. monitoring the order in which the sequence of data sets was obtained; and,
d. issuing an authentication signal if the data sets satisfactorily match the corresponding authentic versions and the sequence of data sets was obtained in a predetermined order.

15. A method according to claim 14, wherein at least one of the plurality of parts of the user's body is a fingertip.

16. A method according to claim 14, wherein at least one of the plurality of parts of the user's body is a retina.

17. A method according to any of claim 14, wherein at least one of the plurality of parts of the user's body is the user's face.
